(19) United States
(12) Patent Application Publication
(10) Pub. No.: US 2020/0125010 A1
(43) Pub. Date: Apr. 23, 2020

(54) INTERMEDIATE TRANSFER MEMBER AND METHOD OF PRODUCTION

(71) Applicant: HP Indigo B.V., Amstelveen (NL)

(72) Inventors: Dima Libster, Ness Ziona (IL); Elina Ploshnik, Ness Ziona (IL); Sergey Inotaev, Ness Ziona (IL); Gabi Habibi, Ness Ziona (IL); Dafna Shunary, Ness Ziona (IL)

(21) Appl. No.: 16/620,795

(22) PCT Filed: Sep. 20, 2017
(86) PCT No.: PCT/EP2017/073822

§ 371 Date: Dec. 9, 2019

(51) Int. Cl. G03G 15/16

(52) U.S. Cl. CPC G03G 15/162

(57) ABSTRACT

Herein is disclosed an intermediate transfer member for liquid electrophotographic printing. The intermediate transfer member comprises a silicone release layer bonded to a layer comprising a thermoplastic polyester polyurethane. A method of producing an intermediate transfer member is also described.

Liquid electrophotographic printing processes typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, an electrophotographic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, in some examples, by being first transferred to an intermediate transfer member, which can be a soft swelling blanket, and then to the print substrate.

### BRIEF DESCRIPTION OF THE FIGURES

FIG. 1 is a schematic illustration of an example of a liquid electrophotographic printing apparatus.

FIG. 2 is a cross-sectional diagram of an example of an intermediate transfer member (ITM); and

FIG. 3 is a schematic cross-sectional diagram of an example of an ITM structure.

### DETAILED DESCRIPTION

Before the intermediate transfer member and related aspects are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “electrophotographic ink composition” generally refers to an ink composition that is typically suitable for use in an electrophotographic printing process, sometimes termed an electrostatic printing process. The electrophotographic ink composition may include chargeable particles of the resin and the pigment dispersed in a liquid carrier, which may be as described herein.

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrophotographic printing” or “electrostatic printing” generally refers to the process that provides an image that is transferred from a photoimaging plate either directly, or indirectly via an intermediate transfer member, to a print substrate. As such, the image is not substantially absorbed into the photoimaging plate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g., an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

In an aspect there is provided a method of producing an intermediate transfer member for digital offset printing, comprising:
applying onto an intermediate transfer member body a layer comprising a thermoplastic polyester polyurethane;
applying a coating of a radiation curable primer onto the layer comprising a thermoplastic polyester polyurethane;
irradiating the coating of radiation curable primer to provide a coating of cured primer;
applying onto the coating of cured primer a curable composition comprising first and second catalysts;
applying onto the curable composition a curable silicone release formulation; and
curing the curable composition and the curable silicone release formulation;
wherein the first catalyst catalyses the curing of the curable composition and the second catalyst catalyses the curing of the curable silicone release formulation.

In a related aspect there is provided an intermediate transfer member for digital offset printing, obtainable by a method comprising:
applying onto an intermediate transfer member body a layer comprising a thermoplastic polyester polyurethane;
applying a coating of a radiation curable primer onto the layer comprising a thermoplastic polyester polyurethane;
irradiating the coating of radiation curable primer to provide a coating of cured primer;
applying onto the coating of cured primer a curable composition comprising first and second catalysts;
applying onto the curable composition a curable silicone release formulation; and
curing the curable composition and the curable silicone release formulation;
wherein the first catalyst catalyses the curing of the curable composition and the second catalyst catalyses the curing of the curable silicone release formulation.

In a related aspect there is provided an intermediate transfer member for digital offset printing, comprising:
an intermediate transfer member body;
a layer comprising a thermoplastic polyester polyurethane disposed on the intermediate transfer member body;
a first primer layer comprising a radiation-cured primer composition disposed on the layer comprising a thermoplastic polyester polyurethane;
a second primer layer disposed on and cross-linked to the first primer layer, the second primer layer comprising a cured primer composition and first and second catalysts, wherein the second catalyst is different to the first catalyst; and
a cured silicone release layer disposed on and cross-linked to the second primer layer.

In a related aspect, there is a provided an electrophotographic printing apparatus, comprising an intermediate transfer member having:
an intermediate transfer member body;
a layer comprising a thermoplastic polyester polyurethane disposed on the intermediate transfer member body;
a first primer layer comprising a radiation-cured primer composition disposed on the layer comprising a thermoplastic polyester polyurethane;
a second primer layer disposed on and cross-linked to the first primer layer, the second primer layer comprising a cured primer composition and first and second catalysts, wherein the second catalyst is different to the first catalyst; and
a cured silicone release layer disposed on and cross-linked to the second primer layer.

Some methods of producing intermediate transfer members in the prior art require using a solvent. For example, such methods may involve depositing and/or curing a material in a solution, possibly while evaporating the solvent from the solution. This can be an expensive process, involving considerable labor and it can be time-consuming. Additionally, some prior art intermediate transfer members have release layers, which may, for example comprise silicone, that are formed on rubber-based soft compliant layers. Methods of making such intermediate transfer members require the release layer to be deposited while the underlying rubber is uncured or only partially cured, meaning transport and storage at low temperatures. Examples of intermediate transfer members having thermoplastic polyester polyurethanes as a soft compliant layer and a silicone release layer are advantageously produced by the methods described herein.

Liquid Electrophotographic (LEP) Printing Apparatus

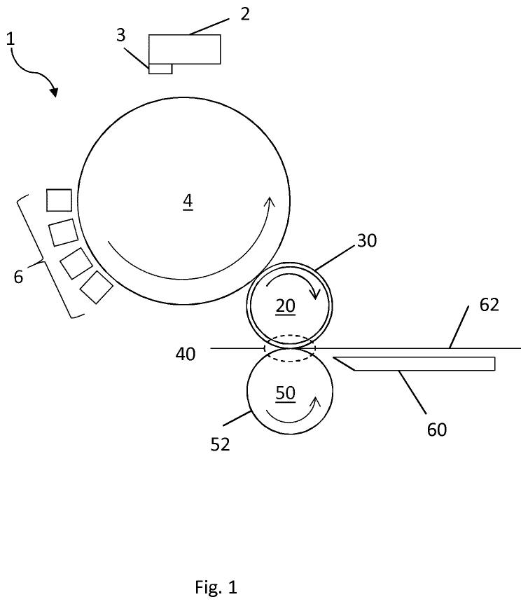

FIG. 1 shows a schematic illustration of an example of an LEP printing apparatus 1 and the use of an intermediate transfer member therein. An image, including any combination of graphics, text and images, is communicated to the LEP printing apparatus 1. The LEP printing apparatus includes a photo charging unit 2 and a photo-imaging cylinder 4. The image is initially formed on a photoimaging plate (also known as a photoconductive member), in this case in the form of a photo-imaging cylinder 4, before being transferred to an outer release layer 30 of the intermediate transfer member (ITM) 20 which is in the form of a roller (first transfer), and then from the outer release layer 30 of the ITM 20 to a print substrate 62 (second transfer).

According to an illustrative example, the initial image is formed on a rotating photo-imaging cylinder 4 by the photo charging unit 2. Firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. Liquid electrophotographic ink is then transferred to the photo-imaging cylinder 4 by binary ink developer (BID) units 6. The BID units 6 present a uniform film of liquid electrophotographic ink to the photo-imaging cylinder 4. The liquid electrophotographic ink contains electrically charged pigment particles which, by virtue of an appropriate potential on the electrostatic image areas, are attracted to the latent electrostatic image on the photo-imaging cylinder 4. The liquid electrophotographic ink does not adhere to the uncharged, non-image areas and forms a developed toner image on the surface of the latent electrostatic image. The photo-imaging cylinder 4 then has a single colour ink image on its surface.

The developed toner image is then transferred from the photo-imaging cylinder 4 to the outer release layer 30 of the ITM 20 by electrical forces. The image is then dried and fused on the outer release layer 30 of the ITM 20 before being transferred from the outer release layer 30 of the ITM 20 to a print substrate disposed on impression cylinder 50. The process may then be repeated for each of the coloured ink layers to be included in the final image.

The image is transferred from the photo-imaging cylinder 4 to the ITM 20 by virtue of an appropriate potential applied between the photo-imaging cylinder 4 and the ITM 20, such that the charged ink is attracted to the ITM 20.

Between the first and second transfers, the solid content of the developed toner image is increased and the ink is fused on to the ITM 20. For example, the solid content of the developed toner image deposited on the outer release layer 30 after the first transfer is typically around 20%, by the second transfer the solid content of the developed toner image is typically around 80-90%. This drying and fusing is typically achieved by using elevated temperatures and airflow-assisted drying. In some examples, the ITM 20 is heatable.

The print substrate 62 is fed into the printing apparatus by the print substrate feed tray 60 and is disposed on the impression cylinder 50. As the print substrate 62 contacts the ITM 20, the single colour image is transferred to the print substrate 62.

To form a single colour image (such as a black and white image), one pass of the print substrate 62 through the impression cylinder 50 and the ITM 20 completes the image. For a multiple colour image, the print substrate 62 is retained on the impression cylinder 50 and makes multiple contacts with the ITM 20 as it passes through the nip 40. At each contact an additional colour plane may be placed on the print substrate 62.

Intermediate Transfer Member

The intermediate transfer member may be termed an ITM herein for brevity. The ITM may have a cylindrical shape, as such the ITM may be suitable for use as a roller, for example a roller in a printing apparatus.

The ITM may comprise a body portion on which other layers as described herein are disposed. For the purposes of the present disclosure, the intermediate transfer member body may comprise or include a metal base. The base may have a cylindrical shape. The base may form part of the body of the ITM.

In some examples, the intermediate transfer member body comprises, in the following order on the base:
a. a fabric layer;
b. a compressible layer, which may have voids therein;
c. a layer comprising electrically conductive particles;
d. the thermoplastic polyester polyurethane layer; and
e. the silicone outer release layer;

In some examples, the thermoplastic polyester polyurethane layer forms or is part of a soft compliance layer of the ITM.

The fabric layer may be, for example, a woven or non-woven cotton, synthetic, combined natural and synthetic, or treated, for example, treated to have improved heat resistance, material. In an example the fabric layer is a fabric layer formed of NOMEX material having a thickness, for example, of about 200 μm.

The compressible layer may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). The compressible layer may comprise a thermoplastic polyurethane. The compressible layer may have a large degree of compressibility. In some examples, the compressible layer may be 600 μm thick. In some examples, the compressible layer includes small voids, which may be as a result of microspheres or blowing agents used in the formation of the compressible layer. In some examples, the small voids comprise about 40 to about 60% by volume of the compressible layer.

In some examples, the layer comprising electrically conductive particles comprises a rubber, for example, an acrylic rubber (ACM), a nitrile rubber (NBR), a hydrogenated nitrile rubber (HNBR), or an EPDM rubber (an ethylene propylene diene terpolymer), and one or more conductive materials. In some examples, the conductive layer comprises a thermoplastic polyurethane and one or more conductive materials. In some examples, the conductive layer may be omitted, such as in some examples in which the compressible layer, the compliance layer, or the release layer are partially conducting. For example, the compressible layer and/or the compliance layer may be made to be partially conducting with the addition of conductive carbon black or metal fibres.

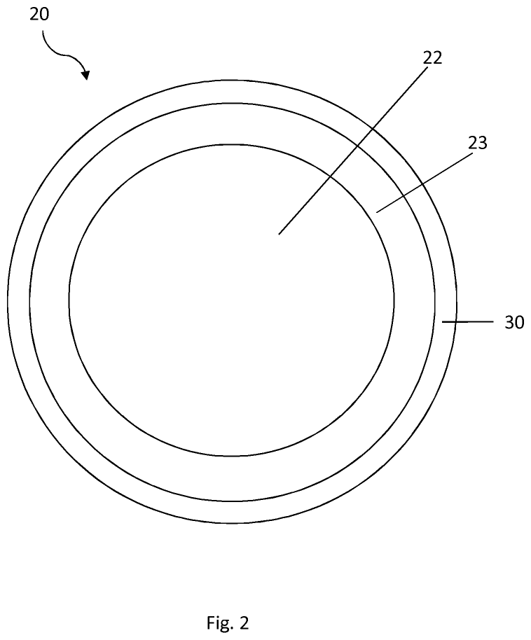

FIG. 2 is a cross-sectional diagram of an example of an ITM. The ITM includes a supportive portion comprising a base 22 (which may include components a to c above) and a substrate layer 23 disposed on the base 22. The substrate layer 23 is or comprises a thermoplastic polyester polyurethane layer. The ITM 20 also comprises an outer release layer 30 disposed on the substrate layer 23. The outer release layer 30 is or comprises a silicone-based release layer.

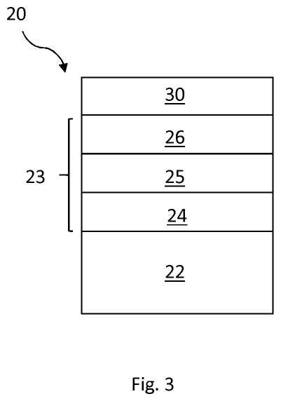

FIG. 3 shows a cross-sectional view of an ITM having a substrate layer 23 comprising a thermoplastic polyester polyurethane soft compliance layer 24 disposed on the base 22, a primer layer 25 for bonding the soft compliance layer 24 of the substrate layer 23 to a layer 26 of a second cured primer composition, on which is disposed an outer silicone release layer 30.

Thermoplastic Polyester Polyurethane

The ITM includes a layer of a thermoplastic polyester polyurethane. The layer of thermoplastic polyester polyurethane may also be referred to as a soft compliant layer or a compliance layer of the ITM.

A thermoplastic material in the present context indicates a material that can become mouldable, pliable or molten when heated to an appropriate temperature from a solid state, and then solidified on cooling, and the process repeated. The thermoplastic polyester polyurethane described herein is not typically cross-linked prior to application onto the ITM. Thermoplastic materials are to be distinguished from thermoset materials, in which the solid materials are formed irreversibly (often ‘cured’) from a liquid state, typically by crosslinking in a polymer network.

Thermoplastic polyester polyurethanes are a class of polyurethane plastics comprising linear segmented block copolymers, which may have hard and soft segments. Thermoplastic polyester polyurethane polymers may be formed by the reaction of three components: diisocyanates, long-chain diols (for example, polyester polyols, or polycaprolactones), which may, for example, have a molecular weight of from at least 500 Daltons and so-called chain extenders (which may be short-chain diols, e.g. having a molecular weight of 400 Daltons or less). Polyester polyurethanes have been found to be particularly effective in the intermediate transfer member as described herein. In some examples, the thermoplastic polyester polyurethane is a thermoplastic aromatic polyester polyurethane.

Long-Chain Diols

The long-chain diol may comprise a polyester polyol, or a polycaprolactone, or combinations thereof.

The polyester polyol may be formed from at least one dialkylene glycol and at least one dicarboxylic acid, or an ester or anhydride thereof. The polyester polyol may contain 2 terminal hydroxyl groups, optionally, 2 primary hydroxyl groups, or the polyester polyol may include at least one terminal hydroxyl group, and in some embodiments, at least one terminal hydroxyl group and one or more carboxylic acid groups. The polyester polyol may be a substantially linear, or linear, polyester, which may have a number average molecular weight (Mn) in the range of from about 500 to about 10,000, from about 600 to about 4000, from about 600 to about 3000, from about 800 to about 3000, from about 1000 to about 2500, or from about 1200 to about 2500. In some examples, the polyester polyol will have a number average molecular weight in the range of from about 1500 to about 2500.

The polyester polyol may be an adipate, a polycaprolactone, a polycarbonate or an aliphatic polycarbonate.

The Diisocyanate

The diisocyanates may be selected from: (i) aromatic diisocyanates, such as, 4,4′-methylenebis-(phenyl isocyanate) (MDI), m-xylylene diisocyanate (XDI), phenylene-1,4-diisocyanate, 1,5-naphthalene diisocyanate, diphenylmethane-3,3′-dimethoxy-4,4′-diisocyanate (TODD, and toluene diisocyanate (TDI); or (ii) aliphatic diisocyanates, such as, isophorone diisocyanate (IPDI), 1,4-cyclohexyl diisocyanate (CHDI), decane-1,10-diisocyanate, hexamethylene diisocyanate (HDI), bis(isocyanatomethyl)cyclohexane (CHMDI) and dicyclohexylmethane-4,4′-diisocyanate (HMDI). In some examples, the diisocyanate is 4,4′-methylenebis(phenyl isocyanate) (MDI).

The Chain Extender

The third reactant used in synthesizing TPU is a so-called chain extender, which may be a short-chain diol. The chain extender may have a molecular weight in the range of from 48 to about 400 or from 61 to about 400.

Suitable chain extenders include glycols and can be aliphatic, aromatic or combinations thereof. In some cases, the chain extenders are glycols having from 2 to about 20 carbon atoms. In some examples, the glycol chain extenders are lower aliphatic or short-chain glycols having from about 4 to about 12 carbon atoms and include, for example, diethylene glycol, dipropylene glycol, 1,4-butane diol, 1,6-hexanediol, 1,3-butanediol, 1,5-pentanediol, 1,4-cyclohexanedimethanol, neopentyglycol, 1,9-nonanediol, 1,12-dodecanediol and the like. In some embodiments, the chain extender is comprised solely of 1,6-hexanediol.

In some examples, the chain extender may comprises an aromatic glycol. In some examples, the aromatic glycol may be benzene glycol or xylene glycol. Xylene glycol may be a mixture of 1,4-di(hydroxymethyl)benzene and 1,2-di(hydroxymethyl)benzene. The benzene glycol may be hydroquinone bis(betahydroxyethyl)ether (HQEE), 1,3-di(2-hydroxyethyl)benzene, 1,2-di(2-hydroxyethoxy)benzene, or combinations thereof.

Diamines may also be used as a chain extender.

Suitable TPUs are available as films, and are available commercially, e.g. Novotex 3CL, Novotex FS1007, Novotex FS1008, Novotex FS2090, Covestro Dureflex PS8400, Covestro Dureflex PS5400.

The TPU may have a Shore A hardness value of less than about 90, less than about 75, less than about 70, less than about 65, or less than or equal to about 60 at room temperature. The TPU may have a Shore A hardness value of greater than about 20, greater than about 30, greater than about 40 at temperature range between 100-110° C. The Shore A hardness value is measured by ASTM D-2240 or DIN ISO 7619-1 (3s) or ISO 868.

In some examples, the layer comprising a thermoplastic polyester polyurethane is applied onto the ITM body at a layer thickness of at least 10 μm, for example at least 20 μm, for example at least 30 μm, for example at least 40 μm, for example at least 50 μm, for example at least 60 μm, for example at least 70 μm, for example at least 80 μm, for example at least 90 μm, for example at least 100 μm, for example at least 110 μm, for example at least 120 μm, for example at least 130 μm, for example at least 140 μm, for example about 150 μm.

In some examples, the layer comprising a thermoplastic polyester polyurethane is applied onto the ITM body at a layer thickness of less than 150 μm, for example less than 140 μm, for example less than 130 μm, for example less than 120 μm, for example less than 110 μm, for example less than 100 μm, for example less than 90 μm, for example less than 80 μm, for example less than 70 μm, for example less than 60 μm, for example less than 50 μm, for example less than 40 μm, for example less than 30 μm, for example less than 20 μm, for example about 10 μm.

First Primer

A first primer layer, which may also be referred to as a radiation curable or radiation cured primer layer, is provided on the outer surface of the TPU layer. The first primer layer may facilitate bonding or joining of the release layer to the TPU layer. The first primer layer may be formed from a radiation curable primer. The radiation curable primer may be applied using a rod coating process or gravure.

In some examples, the radiation curable primer is cured by UV light. The radiation curable primer may comprise a cross-linking compound capable of cross-linking to the outer surface of the TPU layer when irradiated with UV light. In some examples, the radiation curable primer may comprise a functional organosilane. In some examples the organosilane contained in the radiation curable primer layer is selected from an epoxysilane, a vinyl silane, an allyl silane and an unsaturated silane, for example an acrylate functional silane, a methacrylate functional silane, an epoxysilane and mixtures thereof.

In some examples, the functional organosilane compound comprises, for example, a methacryloxypropyl trimethoxysilane, such as Dynasylan® MEMO™ (3-methacryloxypropyltrimethoxysilane) available from Degussa, AG of Piscataway, N.J.

In some examples, an epoxysilane is used in the first primer. In some examples an epoxysilane such as 3-glycidoxypropyl trimethoxysilane (available from ABCR GmbH & Co. KG) is used.

In some examples, the radiation curable primer comprises a photoinitiator to facilitate cross-linking of the functional organosilane to itself and with the surface of the TPU. In some examples, the photoinitiator includes, but is not limited to, α-hydroxyketones, α-aminoketones, benzaldimethyl-ketal, and mixtures thereof. In one example, the photoinitiator can comprise Darocur® 1173™, available from BASF, which comprises 2-hydroxy 2-methyl 1-phenyl 1-propanone, CAS number 7473-98-5. Other suitable photoinitiators include, but are not limited to, Irgacure® 500™ (a 50/50 blend of 1-hydroxy-cyclohexyl phenyl ketone and benzophenone), Irgacure® 651 ™ (an α,α-dimethoxy α-phenyl acetophenone), Irgacure® 907™ (2-methyl-1-[4-(methylthio)phenyl]-2-(4-morpholinyl)-1-propanone) from BASF. Additionally, any other suitable photoinitiator may be used. Generally, the photoinitiator can comprise about 1 wt % to about 20 wt % of the total first primer composition. In one example, the photoinitiator can comprise about 1 wt % to about 5 wt % of the total first primer composition.

In some examples, the coating of the radiation curable primer is applied onto the layer comprising a thermoplastic polyester polyurethane at a layer thickness of less than 10 μm, for example less than 5 μm, for example less than 4 μm, for example less than 3 μm, for example less than 2 μm, for example less than 1 μm, for example less than less than 0.5 μm, for example about 250 nm. In some examples, the coating of the radiation curable primer is applied onto the layer comprising a thermoplastic polyester polyurethane at a layer thickness of more than 250 nm, for example more than 0.5 μm, for example more than 1 μm, for example more than 2 μm, for example more than 4 μm, for example more than 5 μm, for example less than more than 5 μm, for example about 10 μm. In some examples, the coating of the radiation curable primer is applied onto the layer comprising a thermoplastic polyester polyurethane at a layer thickness of from 250 nm 10 μm, for example from 0.5 μm to 5 μm, for example about 1 μm.

Second Primer

A second primer composition, which may also be referred to as a curable composition, is provided on the outer surface of the first primer already applied to the TPU layer. The curable composition is applied to the outer surface of the first primer after curing of the first primer by irradiation. The curable composition may be applied using a rod coating process or gravure. The second primer composition facilitates bonding of the silicone release layer to the TPU layer via the first primer.

In some examples, the curable composition is thermally curable. In some examples, the curable composition comprises a reactive monomer with addition polymerisable groups and condensation polymerisable groups. In some examples, the curable composition comprises a functional silane. Examples of functional silanes that can be used in the curable composition include but are not limited to an epoxysilane, an amino functional silane, an alkylsilane, a vinyl silane, an allyl silane, an unsaturated silane, a non-functional dipodal silane (e.g., bis triethoxysilyl octane), and their condensed forms constituted by oligomers of the monomeric form of the silane.

In some examples, the functional silane comprises a hydrolysable portion. In some examples, the hydrolyzable portion of the silane comprises an alkoxy group (e.g., alkoxysilane with an alkoxy group selected from the group consisting of methoxy, ethoxy, propoxy, isopropoxy, methoxyethoxy, and the like.) In some examples, the functional silane comprises an epoxyalkyl alkoxysilane (e.g., glycidoxypropyl trimethoxysilane-silane Dynasilan GLYMO (Degussa). In some example, the hydrolyzable group may also be an oxime group (e.g., methylethylketoxime group) or an acetoxy group. Another illustrative example of an organosilane useful in the second primer is a hydrolysable vinyl silane, for example vinyltriethoxysilane (VTEO, available from Evonik, Kirschenallee, Darmstadt, 64293, Germany), a hydrolysable allyl silane or a hydrolysable unsaturated silane.

The curable composition comprises first and second catalysts, which are different to each other. In some examples, the first and second catalysts catalyse different types of polymerisation reactions. In some examples the first catalyst catalyses a condensation polymerisation reaction. In some examples the second catalyst catalyses an addition polymerisation reaction. In some examples, the curable composition comprises first and second catalysts, with the first catalyst catalysing the curing of the curable composition and the second catalyst catalysing the curing of the curable silicone release formulation. In some examples, the first catalyst also catalyses the cross-linking of the curable composition to the radiation-cured first primer. In some examples, the second catalyst also catalyses the cross-linking of the curable composition to the curable silicone release formulation.

In some examples, the first catalyst component of the curable composition comprises a titanate or a tin catalyst, or, alternatively, comprises any suitable compound that is capable of catalyzing a condensation curing reaction of the organosilane of the curable composition. In certain embodiments, the first catalyst comprises an organic titanate catalyst such as acetylacetonate titanate chelate, available as Tyzor® AA-75 from E.I. du Pont de Nemours and Company of Wilmington, Del.)

In some examples, the first catalyst comprises about 1 to 20 weight % of the total primer layer. In some examples, the first catalyst comprises about 1 to 5 weight % of the total primer layer. Without being bound by theory, it is believed that acetylacetonate titanate chelate (Tyzor® AA-75) initiates condensation reaction between the first and second primer components, inducing adhesion between the first and second primers.

In some examples, the second catalyst comprises platinum, or any other catalyst capable of catalysing an addition cure curing reaction of the second primer or curable composition as well as an addition cure of the silicone release composition. In some examples, the second catalyst comprises platinum or rhodium. In some examples, the second catalyst comprises a Karstedt catalyst with for example 9% platinum in solution (available from Johnson Matthey, 5th Floor, 25 Farringdon Street, London EC4A 4AB, United Kingdom) or SIP6831.2 catalyst (available from Gelest, 11 East Steel Road, Morrisville, Pa. 19067, USA).

In some examples, the coating of the curable composition primer is applied onto the radiation cured primer layer at a layer thickness of less than 10 μm, for example less than 5 μm, for example less than 4 μm, for example less than 3 μm, for example less than 2 μm, for example less than 1 μm, for example less than less than 0.5 μm, for example about 250 nm. In some examples, the coating of the curable composition primer is applied onto radiation cured primer layer at a layer thickness of more than 250 nm, for example more than 0.5 μm, for example more than 1 μm, for example more than 2 μm, for example more than 4 μm, for example more than 5 μm, for example less than more than 5 μm, for example about 10 μm. In some examples, the coating of the curable composition primer is applied onto the radiation cured primer layer at a layer thickness of from 250 nm 10 μm, for example from 0.5 μm to 5 82 m, for example about 1 μm.

Silicone Release Layer

A silicone release layer or silicone release formulation is provided on the outer surface of the second primer formed from the curable composition. The silicone release layer may be referred to as an outer release layer. A rod coating or gravure process may be used to apply the curable silicone release formulation.

In some examples, the curable silicone release formulation is curable by an addition reaction. In some examples, the curable silicone release formulation is thermally curable. In some examples, the curable silicone release formulation is curable using a catalyst comprising platinum.

In some examples, the outer release layer may comprise a polysiloxane that has been cross-linked using an addition cure process such that it contains Si—R—Si bonds, wherein R is an alkylene moiety, and a monoalkenylsiloxane has been reacted with and incorporated into the polysiloxane.

The curable silicone release layer formulation may comprise at least one silicone oil having alkene groups linked to the silicone chain of the silicone oil; a monoalkenylsiloxane and a cross-linker. In some examples, the cross-linker comprises a silicon hydride component. In some examples, the silicone polymer matrix of the silicone release layer comprises the cross-linked product of the at least one silicone oil, a monoalkenylsiloxane and a silicon hydride cross-linking component. In some examples, the at least one silicone oil comprises a vinyl silicone oil. In some examples the at least one silicone oil comprises a vinyl-terminated polydimethyl siloxane. In some examples, the at least one silicone oil comprises a polyalkenylsiloxane. Examples of polyalkenylsiloxanes for inclusion in the curable silicone release layer formulation include tetramethyltetravinylcyclotetrasiloxane or tetramethyldivinyldisiloxane.

In some examples, the silicone release layer formulation comprises a vinyl-terminated polydimethyl siloxane, for example Polymer VS 500 having a viscosity at 25° C. of 500 mPa·S, and a vinyl content of 0.14 mmol/g (available from Hanse Chemie, Charlottenburger Straβe 9, 21502 Geesthacht, Germany); a vinyl-terminated with in-chain vinyl functionality polydimethyl siloxane, for example Polymer XPRV 5000 having a viscosity at 25° C. of 3000 mPa·S, and a vinyl content of 0.4 mmol/g (available from Hanse Chemie); a silicone polymer containing silicon-hydride groups, for example Crosslinker 210 with a SiH content of 4.2 mmol/g (available from Hanse Chemie).

In some examples, the curable silicone release layer formulation may contain a catalyst, for example, a platinum-containing catalyst or a rhodium-containing catalyst. In some examples, the catalyst comprises a Karstedt catalyst or a catalyst comprising a Pt(O) complex with vinylsiloxane ligands. In some examples, the catalyst comprises a divinyl tetramethyl disiloxane-platinum(0) complex.

In some examples, the curable silicone release formulation comprises a filler. Examples of suitable fillers include carbon black and PTFE particles.

In some examples, the curable silicone release formulation comprises an acetylenic alcohol or an alkinol, as an inhibitor to control the curing process. Suitable examples include Inhibitor 600 from Evonik.

In some examples, the formulation also may contain a volatile solvent as diluting agent. In some examples, the volatile solvent for use as diluting agent comprises isopropanol. It will be understood that other volatile solvents can be used as diluting agent, as long as they are inert to the formulation and are volatile under the processing conditions.

In some examples, the silicone release formulation is applied onto the second primer or curable composition with a layer thickness of at least 1 μm, for example at least 1.5 μm, for example at least 2 μm, for example at least 3 μm, for example at least 4 μm, for example at least 5 μm, for example at least 6 μm, for example at least 7 μm, for example at least 8 μm, for example at least 9 μm, for example at least 10 μm, for example at least 11 μm, for example at least 12 μm, for example at least 13 μm, for example at least 14 μm, for example about 15 μm.

In some examples, the silicone release formulation is applied onto the second primer or curable composition with a layer thickness of less than 15 μm, for example less than 14 μm, for example less than 13 μm, for example less than 12 μm, for example less than 11 μm, for example less than 10 μm, for example less than 9 μm, for example less than 8 μm, for example less than 7 μm, for example less than 6 μm, for example less than 5 μm, for example less than 4 μm, for example less than 3 μm, for example less than 2 μm, for example less than 1.5 μm, for example about 1 μm. For example the silicone release formulation is applied onto the second primer or curable composition with a layer thickness of from 1 μm to 15 μm, for example of from 1.5 μm to 12 μm, for example of from 3 μm to 10 μm, for example of from 5 μm to 9 μm.

Method

In an aspect there is provided a method of producing an intermediate transfer member for digital offset printing, comprising:
applying onto an intermediate transfer member body a layer comprising a thermoplastic polyester polyurethane;
applying a coating of a radiation curable primer onto the layer comprising a thermoplastic polyester polyurethane;
irradiating the coating of radiation curable primer to provide a coating of cured primer;
applying onto the coating of cured primer a curable composition comprising first and second catalysts;
applying onto the curable composition a curable silicone release formulation; and
curing the curable composition and the curable silicone release formulation;
wherein the first catalyst catalyses the curing of the curable composition and the second catalyst catalyses the curing of the curable silicone release formulation.

The method comprises applying onto an intermediate transfer member body a layer comprising a thermoplastic polyester polyurethane. The intermediate transfer member may comprise one or more of a metal base, a fabric layer, a compressible layer and a conductive layer as described herein, with the layer of thermoplastic polyester polyurethane being applied to the conductive layer. In some examples, the layer comprising a thermoplastic polyester polyurethane is as described herein.

In some examples, the layer comprising a thermoplastic polyester polyurethane is applied onto the ITM body by an extrusion, calendering or lamination process. Using these methods, the layer comprising a thermoplastic polyester polyurethane can be processed in a straightforward manner without the use of solvents.

In some examples, a film or sheet of the thermoplastic polyester polyurethane is applied onto the ITM body by a lamination process, in which a release liner is used. In some examples, the release liner comprises a polyethylene-terephthalate (PET) liner or a metallized PET liner. In some examples, the release liner is thermally stable, in order to allow lamination at high temperatures. The release liner provides for a smooth surface and high surface energy of the thermoplastic polyester polyurethane layer, which in turn allows for high levels of adhesion of the silicone release layer.

In some examples, a film or sheet of the thermoplastic polyester polyurethane is applied onto the ITM body by a lamination process at a temperature approximately 15° C. higher than the melting temperature of the thermoplastic polyester polyurethane.

In some examples, the layer comprising a thermoplastic polyester polyurethane is applied onto the ITM body at a layer thickness as described previously.

The method comprises applying a coating of a radiation curable primer onto the layer comprising a thermoplastic polyester polyurethane. In some examples, the coating of a radiation curable primer is applied using a gravure or calendaring process.

In some examples, the coating of the radiation curable primer is applied onto the layer comprising a thermoplastic polyester polyurethane at a layer thickness as described previously. In some examples, the composition of the radiation curable primer is as described herein.

The method comprises irradiating the coating of radiation curable primer to provide a coating of cured primer. In some examples, the coating of radiation curable primer is irradiated with light having a wavelength that corresponds to the optimal wavelength for the photoinitiator. In some examples, the step of irradiating comprising irradiating the coating of radiation curable primer using UV irradiation. The duration of the irradiation will depend on the power rating of the radiation source being used and the actual power supplied. In some examples, irradiating the coating of radiation curable primer comprises irradiating in order to fully cure the primer. In some examples, irradiating the coating of radiation curable primer comprises irradiating in order to at least partially cure the primer. Without being bound by theory, it is believed that irradiation causes the photoinitiator to form bonds with the polyester TPU and with the silane at the surface. In some examples, the radiation-cured primer composition comprises a polymerisation product of an epoxysilane, a vinyl silane, an allyl silane, an acrylate functional silane, and a methacrylate functional silane, and mixtures thereof.

The method comprises applying onto the coating of cured primer a second primer in the form of a curable composition comprising first and second catalysts. In some examples, the curable composition is applied using a gravure or calendaring process. In some examples, the composition of the curable composition is as described herein.

In some examples, the coating of the curable composition primer is applied onto the radiation cured primer layer at a layer thickness as described previously.

The method comprises applying onto the curable composition a curable silicone release formulation. The curable silicone release formulation is applied onto the curable composition before any substantial curing of the curable composition has taken place. In some examples, the curable silicone release formulation is applied onto the curable composition at a layer thickness as described previously.

The method comprises curing the curable composition and the curable silicone release formulation. In some examples, the method comprises curing the curable composition and the curable silicone release formulation by heating to a temperature of at least 100° C., for example at least 110° C., for example at least 120° C., for example at least 130° C., for example at least 140° C., for example at least 150° C., for example at least 160° C., for example about 165° C.

In some examples, the method comprises curing the curable composition and the curable silicone release formulation by heating to a temperature of less than 165° C., for example less than 160° C., for example less than 150° C., for example less than 140° C., for example less than 130° C., for example less than 120° C., for example less than 110° C., for example about 100° C.

In some examples, the method comprises curing the curable composition and the curable silicone release formulation by heating to a temperature as described above for at least 10 seconds, for example at least 30 seconds, for example at least 40 seconds, for example at least 50 seconds, for example at least 1 minute, for example at least 2 minutes, for example at least 3 minutes, for example at least 4 minutes, for example at least 5 minutes, for example at least 10 minutes, for example at least 15 minutes, for example at least 20 minutes, for example about 30 minutes.

In some examples, the method comprises curing the curable composition and the curable silicone release formulation by heating to a temperature as described above for less than 30 minutes, for example less than 20 minutes, for example less than 15 minutes, for example less than 10 minutes, for example less than 5 minutes, for example less than 4 minutes, for example less than 3 minutes, for example less than 2 minutes, for example less than 1 minute, for example less than 50 seconds, for example less than 40 seconds, for example less than 30 seconds, for example about 10 seconds.

In some examples, the method comprises curing the curable composition and the curable silicone release formulation by heating to a temperature of at least 150° C. for less than 2 minutes, for example heating to a temperature of about 165° C. for less than 1 minute. In some examples, the method comprises curing the curable composition and the curable silicone release formulation by heating to a temperature of at least 120° C. for about 15 minutes.

In some examples, the second primer layer comprises a polymerisation product of a reactive monomer having an addition polymerisable group and a condensation polymerisable group. In some examples, the cured silicone release layer comprises a polymerisation product comprising a polysiloxane that has been cross-linked using an addition cure process such that it contains Si—R—Si bonds, wherein R is an alkylene moiety, and a monoalkenylsiloxane has been reacted with and incorporated into the polysiloxane.

### EXAMPLES

The following Examples illustrate a number of variations of intermediate transfer members. However, it is to be understood that the following are only examples or illustrative of the application of the principles of the present printing apparatus, intermediate transfer member and related aspects. Numerous modifications and alternative intermediate transfer members may be made without departing from the spirit and scope of the intermediate transfer member and related aspects. The appended claims are intended to cover such modifications and arrangements. Thus, while the present methods and related aspects have been described above with particularity, the following examples provide further detail in connection with what are presently deemed to be acceptable.

Preparation of an ITM Having a TPU Soft Compliant Layer

Lamination of TPU films was performed onto the rubber based conductive layer of an ITM body having the following structure from bottom to top (top is a release layer, bottom is a fabric based support layer which is in contact with a metal ITM drum):

1. Fabric based support layer.

2. Rubber based compressible layer (NBR from ContiTech AG Vahrenwalder Str. 9 30165 Hannover Germany).

3. Rubber based conductive layer (NBR from ContiTech)

Lamination of the commercially available polyester 100 microns thickness TPU films of Novotex-3CL (produced by Novotex Italy) was performed at the following conditions:

Temperature: 150° C., Pressure: 3 Bars, Speed: 0.5 meters/min.

Lamination of the commercially available polyether TPU films of Covestro 4201-150 microns thickness (Covestro Germany), was performed at the following conditions:

Temperature: 185° C., Pressure: 3 Bars, Speed: 0.5 meters/min.

Lamination was conducted with a liner, in order to provide very smooth surface to TPU and preserve it from direct heat damage. The liner was selected from a polyethylene terephthalate (PET) liner (70 μm thickness, produced by 3M) or a silicone paper liner (100 μm thickness, produced by 3M.

Primer 1 Preparation

Primer 1 composition comprising Dynasylan® MEMO™, GLYMO™, and Darocur® 1173 was prepared by mixing the components (Table 1).

TABLE 1

| | Wt. % in | |
|---|---|---|
| Materials of primer | formulation | Supplier |
| 3-Glycidoxypropyl) | 45 | ABCR |
| trimethoxysilane | | |
| Dynasylan ® | 50 | Degussa, AG of |
| MEMO ™ (3- | | Piscataway, N.J. |
| methacryloxypropyltrimethoxysilane) | | |
| Darocur 1173 ™, | 5 | BASF |
| 2-hydroxy 2-methyl | | |
| 1-phenyl 1-propanone | | |

Primer 2 Preparation

Primer 2 composition was prepared by mixing the following components (Table 2)

TABLE 2

| | Wt. % in | |
|---|---|---|
| Materials of primer | formulation | Supplier |
| 3-Glycidoxypropyl) | 52 | ABCR |
| trimethoxysilane | | |
| Vinyltrimethoxysilane | 35 | ABCR |
| Tyzor AA75 | 10 | Dorf Ketal |
| Karstedt solution 9% | 3 | Johnson Matthey |
| Pt | | |

Curable Release Layer Formulation Preparation (Formulation A)

A curable release layer formulation was prepared by providing 1000 g of silicone oil (800 grams of Dimethylsiloxane vinyl terminated (vs500), and 200 grams of Vinylmethylsiloxane—Dimethylsiloxane Copolymer vinyl terminated (xprv5000)). 10 g of conductive carbon black (Ketjenblack EC600JD) (1 wt. % by weight on basis of silicone oil) was added to the silicone oil and processed by high shear mixer for 6 minutes at shear rate of 6000 rpm.

Afterwards, 100 g Hydride siloxane Crosslinker 210, 50 g Inhibitor 600 and 5 gr Karstedt solution 0.5% Pt were then added to the obtained formulation (complete

Formulation A set out in table 3 below) and mixed for 2 min at 6000 rpm.

TABLE 3

| | | Dynamic | | |
|---|---|---|---|---|
| | Mass | Viscosity | Functional | |
| Materials | (g) | (mPa · s) | group content | Supplier |
| Dimethylsiloxane vinyl | 800 | 500 | 0.14 Vinyl | ABCR |
| terminated (vs500) | | | (mmole/g) | |
| Vinylmethylsiloxane- | 200 | 3000 | 0.4 Vinyl | |
| Dimethylsiloxane | | | (mmole/g) | |
| Copolymer vinyl | | | | |
| terminated (xprv5000) | | | | |
| Hydride siloxane | 100 | 900 | 4.2 SiH | ABCR |
| Crosslinker 210 | | | (mmole/g) | |
| Inhibitor 600 | 50 | 900 | 0.11 Vinyl | |
| | | | (mmole/g) | |
| Karstedt solution | 5 | 500 | 0.14 Vinyl | ABCR |
| 0.5% Pt | | | (mmole/g) | |
| Conductive Carbon | 10 | | | |
| black Ketjenblack | | | | |
| EC600JD | | | | |

Curable Release Layer Formulation Preparation (Formulation B)

A formulation having a higher concentration of carbon black, with addition of volatile solvent (isopropanol) and addition of PTFE submicron particles was prepared.

The curable release layer formulation was prepared by providing 1000 g of silicone oil (800 grams of Dimethylsiloxane vinyl terminated (vs500), and 200 grams of Vinylmethylsiloxane—Dimethylsiloxane Copolymer vinyl terminated (xprv5000)). The silicone oil was diluted with 700 g of Isopropanol (70 wt % on basis of silicone oil). 25 g of conductive carbon black (Ketjenblack EC600JD) (2.5 wt.% by weight on basis of silicone oil) and 10 g of Fluon FL1700 PTFE particles (1 wt.% by weight on basis of silicone oil) were added to the silicone oil. The curable release layer formulation was processed by high shear mixer for 6 minutes at shear rate of 6000 rpm.

Release layers were formed in the same way as Formulation A when 100 g Hydride siloxane Crosslinker 210, 50 g Inhibitor 600 and 5 gr Karstedt solution 0.5% Pt were then added to the processed curable release layer formulation of Example 1 and mixed for 2 min at 6000 rpm.

Blanket Fabrication Process

Primer 1 composition was applied to ITMs having laminated TPU layers as described above by using a gravure coating process. Primer 1 was UV cured under 300 W/in Fusion H ultraviolet lamp at a line speed of 5 meters per minute. Afterwards Primer 2 was applied by using a gravure coating process. Immediately after that a curable release layer formulation having the composition of Formulation A or B (as described above) was then provided on the primer layer using a gravure coating process. After the coating process was complete, the whole ITM was placed in an oven at 120° C. for 15 minutes to cure.

Wet Abrasion Test

Table 4 gives the results of a wet abrasion test in which the blanket is soaked in a high-purity isoparaffinic solvent for 1 min at room temperature and then abraded with nonwoven wipes (Nonwoven Polyester/cellulose, produced by Essentra Porous Technologies, Chicopce, Mass., USA) The results are scaled as follows: 1=bad, release layer easily removed; 2=fair, release layer removed with small effort; 3=good, release layer removed only with great effort; 4=excellent, release layer cannot be removed.

TABLE 4

| | | | UV | | Release | |
|---|---|---|---|---|---|---|
| | | Prim- | treat- | Prim- | layer | Abrasion |
| TPU | Liner | er 1 | ment | er 2 | formulation | test |
| Novotex-3CL | PET | Yes | Yes | Yes | A | 4 |
| Novotex-3CL | PET | Yes | Yes | Yes | B | 4 |
| Novotex-3CL | PET | No | No | Yes | A | 2 |
| Novotex-3CL | PET | Yes | Yes | No | A | 1 |
| Novotex-3CL | Silicone | Yes | Yes | Yes | A | 1 |
| | paper | | | | | |
| Covestro | PET | Yes | Yes | Yes | A | 1 |
| 4201- | | | | | | |
| polyether | | | | | | |

The results of Table 4 show that excellent adhesion of silicone release to polyester TPU of various compositions can be achieved using the two-primer system with UV treatment, comprising TPU lamination with PET liner. Using only one of the two primers is insufficient to obtain good adhesion. Bad results of wet abrasion test were obtained with polyether TPU, suggesting an important role of polyester polyol in the adhesion process. In addition, using PET liner during TPU lamination is beneficial for TPU adhesion to silicone release layer, as compared to silicone paper liner. TPU surface energy after lamination and liner removal is a clearly an important blanket parameter regarding the process. Primer solution is applied to the CSL surface as droplets from the gravure roll. These must spread to a contiguous film in the 10 seconds between the primer and release layer coating stations, and thereby also facilitate spreading of the release layer droplets to touch one another and form a solid film. The CSL surface energy is a key determinant in the rate of wetting.

It was revealed (Table 5) that lower water and diodomethane contact angles with higher surface free energy were obtained after PET liner lamination, as compared to silicone paper liner lamination. In addition, these liners should supply high surface energy to the laminated TPU. High surface energy of TPU is favourable for TPU-silicone adhesion. Liners like silicone paper induce too low surface energy of the laminated TPU, probably by silicone contamination of the TPU surface.

TABLE 5

| | Water mean | Diodomethane (CH₂I₂) | Surface free |
|---|---|---|---|
| Substrate | contact angle (°) | mean contact angle (°) | energy (mN/m) |
| TPU after | 100.9 (±2.8) | 65.6 (±1.3) | 26.8 (±1) |
| Silicone paper | | | |
| lamination | | | |
| TPU after PET | 80.1 (±0.3) | 37.1 (±0.25) | 44.2 (±0.2) |
| liner lamination | | | |

While the intermediate transfer members and related aspects have been described with reference to certain examples, those skilled in the art will appreciate that various modifications, changes, omissions, and substitutions can be made without departing from the spirit of the disclosure. It is intended, therefore, that the present method and related aspects be limited only by the scope of the following claims. The features of any dependent claim can be combined with the features of any of the other dependent claims or independent claims.

1. A method of producing an intermediate transfer member for digital offset printing, comprising:
applying onto an intermediate transfer member body a layer comprising a thermoplastic polyester polyurethane;
applying a coating of a radiation curable primer onto the layer comprising a thermoplastic polyester polyurethane;
irradiating the coating of radiation curable primer to provide a coating of cured primer;
applying onto the coating of cured primer a curable composition comprising first and second catalysts;
applying onto the curable composition a curable silicone release formulation; and
curing the curable composition and the curable silicone release formulation;
wherein the first catalyst catalyses the curing of the curable composition and the second catalyst catalyses the curing of the curable silicone release formulation.

2. The method according to claim 1, wherein the thermoplastic polyester polyurethane comprises a thermoplastic aromatic polyester polyurethane.

3. The method according to claim 1, wherein the radiation curable primer comprises an organosilane selected from an epoxysilane, a vinyl silane, an allyl silane, an acrylate functional silane, and a methacrylate functional silane, and mixtures thereof.

4. The method according to claim 1, wherein the curable composition comprises a reactive monomer having an addition polymerisable group and a condensation polymerisable group.

5. The method according to claim 1, wherein the first catalyst comprises an organo titanate catalyst and the second catalyst comprises a platinum catalyst or a rhodium catalyst.

6. The method according to claim 1, wherein the first catalyst further catalyses the cross-linking of the radiation curable primer to the thermoplastic polyester polyurethane.

7. The method according to claim 1, wherein the second catalyst further catalyses the cross-linking of the curable composition to the curable silicone release formulation.

8. The method of claim 1, wherein the thermoplastic polyester polyurethane is made by reacting at least one polyester polyol intermediate with at least one diisocyanate and at least one chain extender.

9. The method according to claim 1, wherein the layer comprising a thermoplastic polyester polyurethane is laminated to the intermediate transfer member body using a PET release liner.

10. An intermediate transfer member for digital offset printing, comprising:
an intermediate transfer member body;
a layer comprising a thermoplastic polyester polyurethane disposed on the intermediate transfer member body;
a first primer layer comprising a radiation-cured primer composition disposed on the layer comprising a thermoplastic polyester polyurethane;
a second primer layer disposed on and cross-linked to the first primer layer, the second primer layer comprising a cured primer composition and first and second catalysts, wherein the second catalyst is different to the first catalyst; and
a cured silicone release layer disposed on and cross-linked to the second primer layer.

11. The intermediate transfer member according to claim 10, wherein the radiation-cured primer composition comprises a polymerisation product of an epoxysilane, a vinyl silane, an allyl silane, an acrylate functional silane, and a methacrylate functional silane, and mixtures thereof.

12. The intermediate transfer member according to claim 10, wherein the second primer layer comprises a polymerisation product of a reactive monomer having an addition polymerisable group and a condensation polymerisable group.

13. The intermediate transfer member according to claim 10, wherein the first primer layer is cross-linked to the layer comprising a thermoplastic polyester polyurethane

14. The intermediate transfer member according to claim 10, wherein the thermoplastic polyester polyurethane comprises a thermoplastic aromatic polyester polyurethane.

15. An intermediate transfer member for digital offset printing, obtainable by a method comprising:
applying onto an intermediate transfer member body a layer comprising a thermoplastic polyester polyurethane;
applying a coating of a radiation curable primer onto the layer comprising a thermoplastic polyester polyurethane;
irradiating the coating of radiation curable primer to provide a coating of cured primer;
applying onto the coating of cured primer a curable composition comprising first and second catalysts;
applying onto the curable composition a curable silicone release formulation; and
curing the curable composition and the curable silicone release formulation;
wherein the first catalyst catalyses the curing of the curable composition and the second catalyst catalyses the curing of the curable silicone release formulation.
